(19) United States
(12) Patent Application Publication
(10) Pub. No.: US 2013/0176406 A1
(43) Pub. Date: Jul. 11, 2013

(54) MULTI-LAYER OPTICAL ELEMENTS OF A THREE-DIMENSIONAL DISPLAY FOR REDUCING PSEUDO-STEREOSCOPIC EFFECT

(71) Applicant: Martin Ek, Dalby (SE)

(72) Inventor: Martin Ek, Dalby (SE)

(73) Assignee: SONY ERICSSON MOBILE COMMUNICATIONS AB, Lund (SE)

(21) Appl. No.: 13/823,279

(22) PCT Filed: Mar. 23, 2011
(86) PCT No.: PCT/IB2011/051239

§ 371 Date: Mar. 14, 2013

(51) Int. Cl. H04N 13/04

(52) U.S. Cl. CPC H04N 13/04
USPC 348/51

(57) ABSTRACT

A device may include sensors for obtaining tracking information associated with a user, a display including pixels for displaying images, and an optical guide including two layers of optical elements, each of the optical elements blocking or directing light rays from one or more of the pixels. In addition, the device may include one or more processors to determine a relative location of the user based on the tracking information obtained by the sensors, control optical characteristics of each of the two layers of optical elements based on the relative location of the user, and display a stereoscopic image via the display.

### BACKGROUND

A three-dimensional (3D) display may provide a stereoscopic effect (e.g., an illusion of depth) by rendering two slightly different images, one image for the right eye (e.g., a right-eye image) and the other image for the left eye (e.g., a left-eye image) of a viewer. When each of the eyes sees its respective image on the display, the viewer may perceive a stereoscopic image.

### SUMMARY

According to one aspect, a method may include determining a position of a user relative to a display of a device to obtain position information, wherein the device includes the display and an optical guide, wherein the display includes pixels for displaying images, and wherein the optical guide includes at least two layers of optical elements for directing light rays from the pixels. The method may also include obtaining control values based on the position information, displaying a stereoscopic image at the display, and changing sweet spots associated with the optical guide based on the obtained control values.

Additionally, obtaining the control values may include, for each of the at least two layers, selecting one of an opaque state or a transparent state.

Additionally, changing the sweets spots may include replacing sweet spots that are associated with one of the two layers with sweet spots that are associated with the other of the two layers.

Additionally, the at least two layers may include a parallax barrier element layer; a prism element layer; a grating element layer; or a lenticular lens element layer.

Additionally, obtaining the control values may include selecting values for controlling micro-electromechanical system (MEMS) component, a muscle wire, memory alloys, a piezoelectric component, or controllable polymer to rotate or translate the optical elements.

Additionally, the stereoscopic image may include a right-eye image and a left-eye image. Additionally, changing the sweet spots may include directing the right-eye image to the right-eye of the user during a first time interval, and directing the left-eye image to the left-eye of the user during a second time interval following the first time interval.

Additionally, the method may further include receiving a user selection of a predefined location associated with receiving the stereoscopic image.

Additionally, the method may further include: determining a second position of a second user relative to the display to obtain second position information, displaying a second stereoscopic image at the display concurrently with the stereoscopic image, and controlling the at least two layers of optical elements to send light rays from the pixels of the display to convey the second stereoscopic image to the second position of the second user.

Additionally, obtaining the control values may include determining values for control variables associated with the at least two layers of optical elements to change relative power associated with the stereoscopic image in relation to power associated with the pseudo-stereoscopic image at the determined position of the user.

Additionally, determining the values may include looking up a table of values of the control variables, wherein the values are pre-computed based on ratios of the power associated with the stereoscopic image to the power associated with the pseudo-stereoscopic image.

Additionally, looking up may include identifying the values for the control variables based on the position of the user.

According to another aspect, a device may include sensors for obtaining tracking information associated with a user, a display including pixels for displaying images, and an optical guide including two layers of optical elements, each of the optical elements blocking or directing light rays from one or more of the pixels. The device may also include one or more processors to determine a relative location of the user based on the tracking information obtained by the sensors, control optical characteristics of each of the two layers of optical elements based on the relative location of the user, and display a stereoscopic image via the display.

Additionally, the sensors may include at least one of a gyroscope; a camera, a proximity sensor, or an accelerometer.

Additionally, the device may include a tablet computer, a cellular phone, a personal digital assistant, a personal computer, a laptop computer, a camera, or a gaming console.

Additionally, the two layers may include at least one of a parallax barrier element layer, a lenticular lens element layer, a prism element layer, or a grating element layer.

Additionally, the two layers may be configured to overlap one another. Additionally, sweet spots that are associated with one of the two layers may be located between sweet spots that are associated with the other of the two layers.

Additionally, optical elements of one of the two layers may be opaque when optical elements of the other of the two layers are transparent.

Additionally, the one or more processors may be further configured to prevent a formation of a pseudo-stereoscopic image. Additionally, the stereoscopic image may include a right eye image and a left-eye image at a right-eye position and a left-eye position that are associated with the relative location, respectively, and the pseudo-stereoscopic image may include one of a left-eye image or a right-eye image at the right-eye position and the left-eye position, respectively.

Additionally, when the one or more processors control the optical characteristics, the one or more processors may be further configured to shift sweets spots associated with the display from one set of locations to another set of locations.

According to yet another aspect, a device may include sensors for providing tracking information associated with a user, a display including pixels, a first layer of parallax barrier elements for allowing or blocking light rays from one or more of the pixels to a right eye or a left eye of the user, and a second layer of parallax barrier elements for allowing or blocking light rays from the one or more of the pixels to the right eye or the left eye of the user. The device may also include one or more processors to determine a relative location of the user based on the tracking information, obtain values of control variables for the first layer and the second layer based on the relative location of the right eye and the left eye, display a stereoscopic image via the display, the stereoscopic image comprising a right-eye image and a left-eye image, and change visibility states of the first layer and the second layer of parallax barrier elements based on the control values, to shift a sweet spot associated with the stereoscopic image toward the right eye and left eye of the user.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1A is a diagram of an exemplary three-dimensional (3D) system in which concepts described herein may be implemented;

FIG. 1B illustrates generation of a pseudo-stereoscopic image in the system of FIG. 1A;

FIGS. 2A and 3B are front and rear views of one implementation of an exemplary device of FIG. 1A;

FIG. 3 is a block diagram of components of the exemplary device of FIG. 1A;

FIG. 4 is a block diagram of exemplary functional components of the device of FIG. 1A;

FIGS. 5A and 5B illustrate exemplary operation of the optical guide of the device of FIG. 1A according to one embodiment;

FIGS. 6A and 6B illustrate exemplary operation of the optical guide of the device of FIG. 1A according to another embodiment; and

FIG. 7 is a flow diagram of an exemplary process for eliminating pseudo-stereoscopic images by the device of FIG. 1A.

### DETAILED DESCRIPTION

The following detailed description refers to the accompanying drawings. The same reference numbers in different drawings may identify the same or similar elements. In addition, the terms “viewer” and “user” are used interchangeably.

### Overview

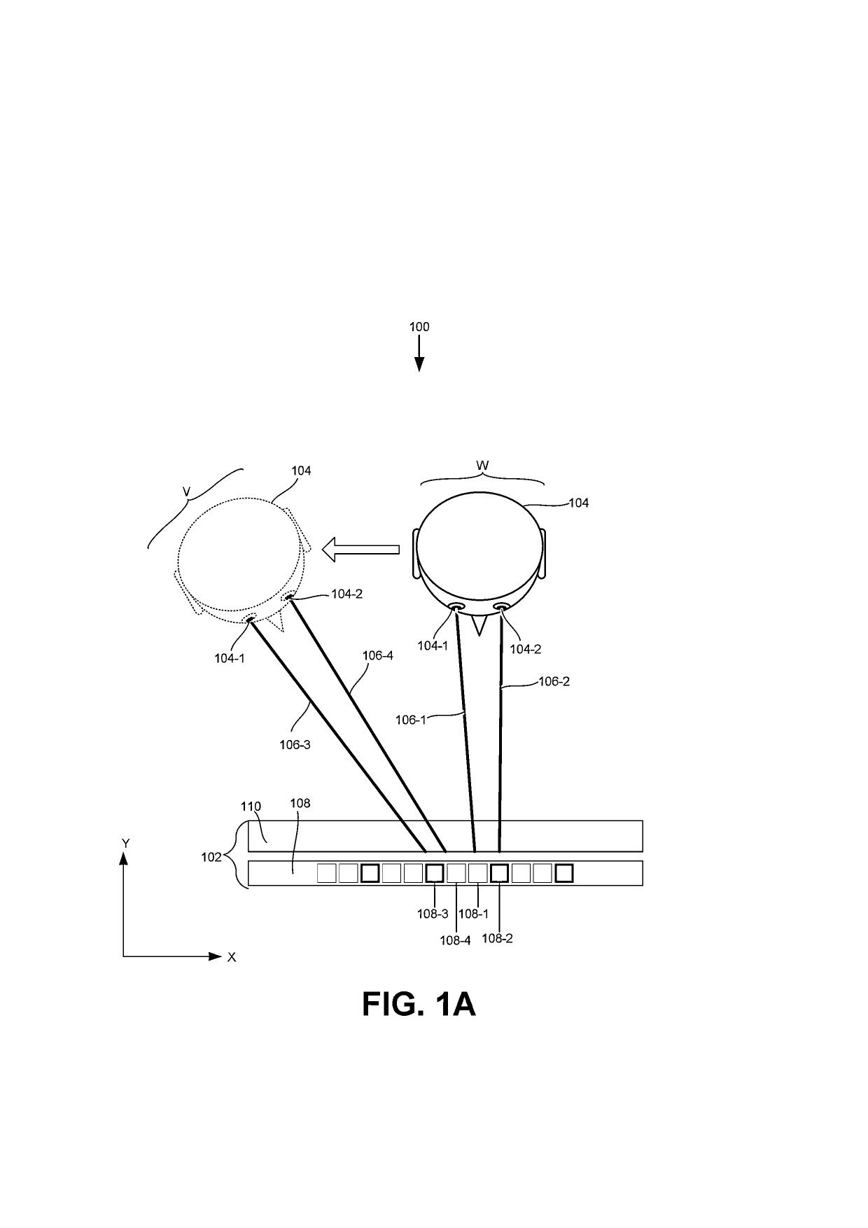

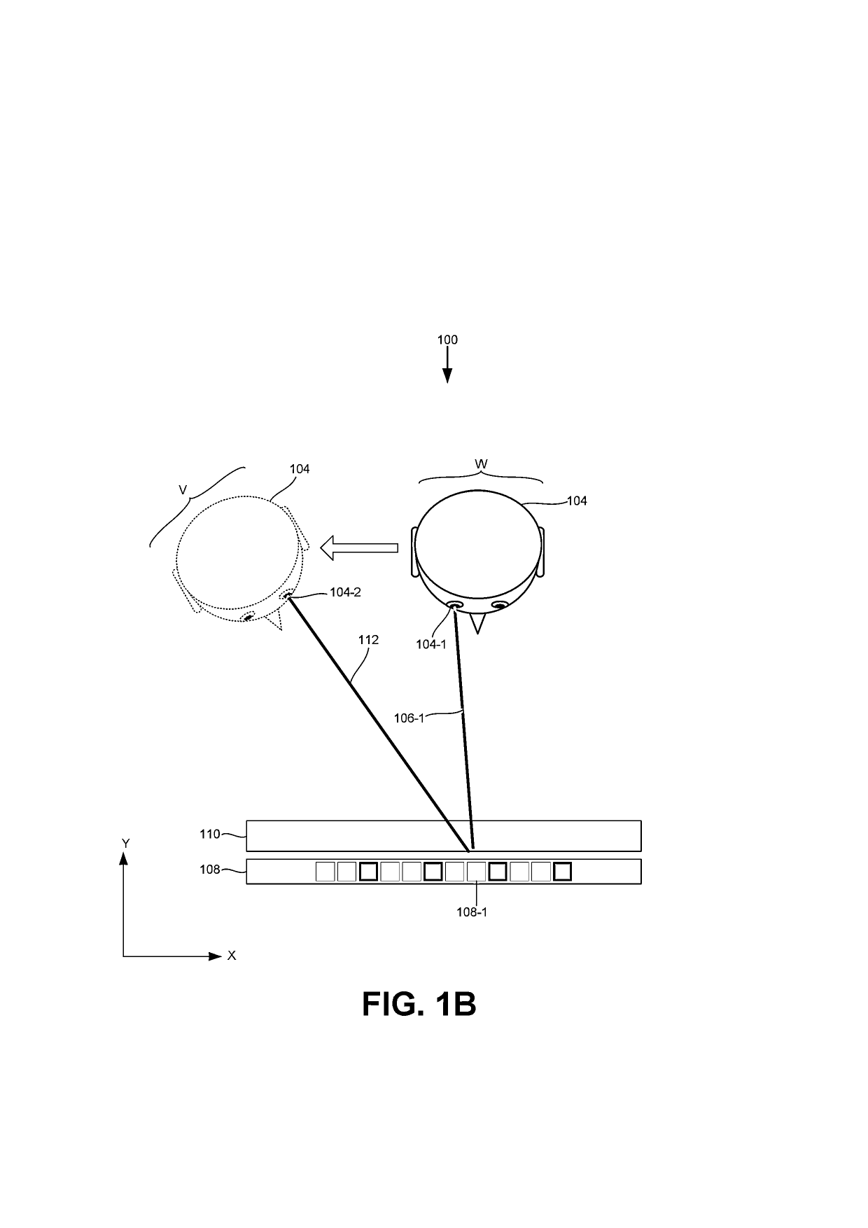

Aspects described herein provide a visual three-dimensional (3D) effect based on device tracking, viewer tracking, and controlling an optical guide that includes multiple layers of optical elements. As further described below, the optical guide may be implemented and operated in different ways. FIG. 1A is a diagram of an exemplary 3D system 100 in which concepts described herein may be implemented. As shown, 3D system 100 may include a device 102 and a viewer 104. Device 102 may generate and provide two-dimensional (2D) or 3D images to viewer 104 via a display. When device 102 shows a 3D image, the right eye 104-1 and the left-eye 104-2 of viewer 104 may receive a right-eye image and a left-eye image via light rays 106-1 and 106-2 that emanate from device 102. Light rays 106-1 and 106-2 may carry different visual information, such that, together, they provide a stereoscopic image to viewer 104.

Device 102 may include a display 108 and optical guide 110. Display 108 may include picture elements (pixels) for displaying images for right eye 104-1 and left eye 104-2. In FIG. 1A, pixels 108-1 and 108-3 are part of right-eye images and pixels 108-2 and 108-4 are part of left-eye images. Optical guide 110 directs light rays from right-eye image pixels to right eye 104-1 and left-eye image pixels to left eye 104-2. As described below, optical guide 110 may include multiple layers of optical elements.

In FIG. 1A, device 102 may not radiate or transmit the left-eye image and the right-eye image in an isotropic manner. Accordingly, at certain locations, viewer 104 may receive the best-quality stereoscopic image that device 102 is capable of conveying. As used herein, the term “sweet spots” may refer to locations at which viewer 104 can perceive relatively high quality stereoscopic images. At other locations, viewer 104 may receive incoherent images. As used herein, the term “pseudo-stereoscopic image” may refer to the incoherent images or low quality images.

In FIG. 1A, viewer 104's position or location relative to device 102 may change. For example, as shown, viewer 104 may change from position W to position V. The change in the relative position may result from viewer 104's movement (e.g., translation, rotation, etc.) or from device 102's movement (e.g., translation, rotation, etc.).

In FIG. 1A, when viewer 104 moves from W to V, optical guide 110 may change its configuration, to continue to guide light rays to right eye 104-1 and left eye 104-2 from corresponding right-eye and left-eye images, respectively, on display 108, such that viewer 104 continues to perceive 3D images. For example, when viewer 104 moves from position W to position V, optical guide 110 guides light rays 106-3 and 106-4 from pixels 108-3 and 108-4 to right eye 104-1 and left eye 104-2, respectively.

In another example, when viewer 104 moves from position W to position V, optical guide 110 prevents light rays from inappropriate or wrong image pixels from reaching right eye 104-1 and left eye 104-2. The light rays from the inappropriate image pixels may result in viewer 104's perception of a pseudo-stereoscopic image. This may interfere with viewer's perception of high quality 3D images.

FIG. 1B illustrates generation of a pseudo-stereoscopic image in 3D system 100. In FIG. 1B, when viewer 104 moves from W to V, viewer 104 may receive, on left eye 104-2, light rays (e.g., light ray 112) from right-eye image pixels (e.g., pixel 108-1). Similarly, although not shown, viewer 104 may receive, on right eye 104-1, light rays from left-eye image pixels. This may result in viewer 104 perceiving a pseudo-stereoscopic image.

In FIGS. 1A and 1B, device 102 may send appropriate right-eye and left eye images to right eye 104-1 and left eye 104-2, respectively, and eliminate or decrease the power associated with pseudo-stereoscopic image(s), by adjusting one or more layers of optical elements in optical guide 110 based on viewer 104 tracking and device 102 tracking In effect, this may enlarge the sweet spot for the user.

### Exemplary Device

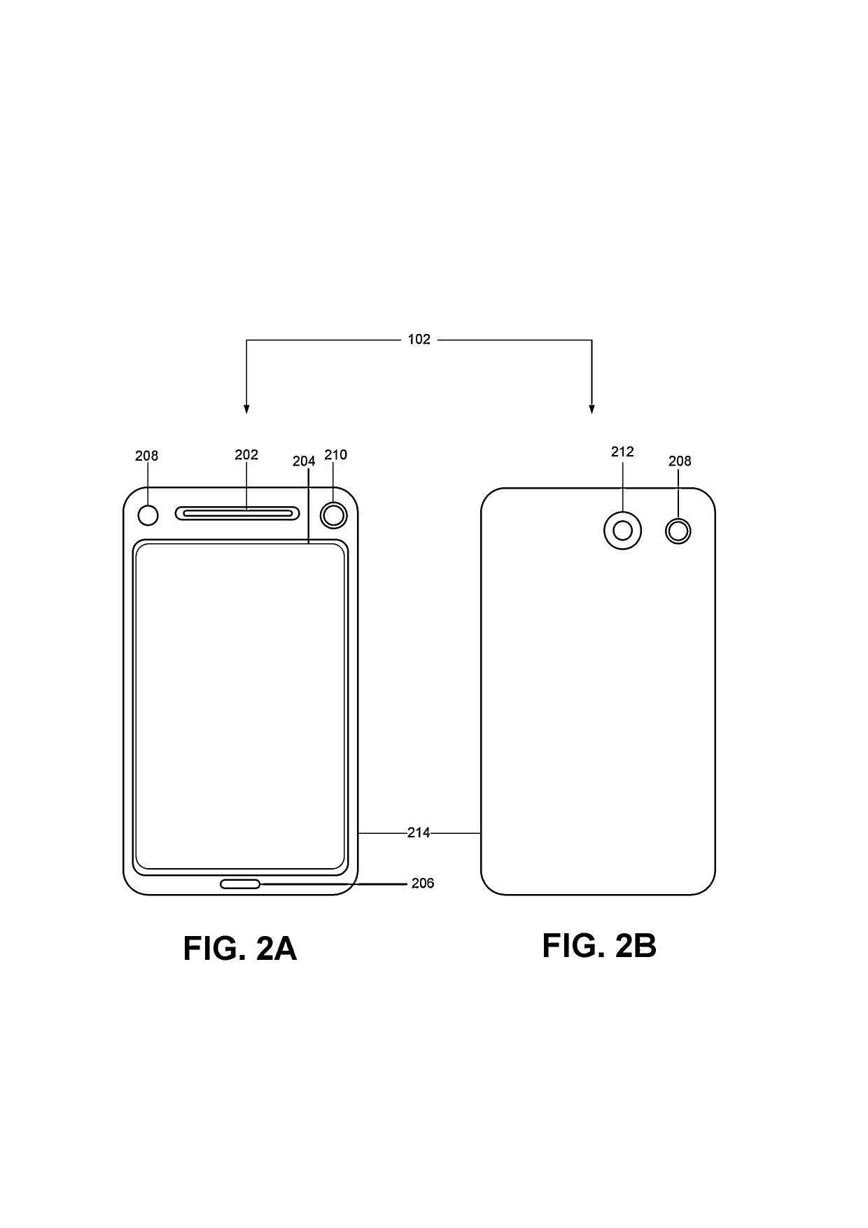

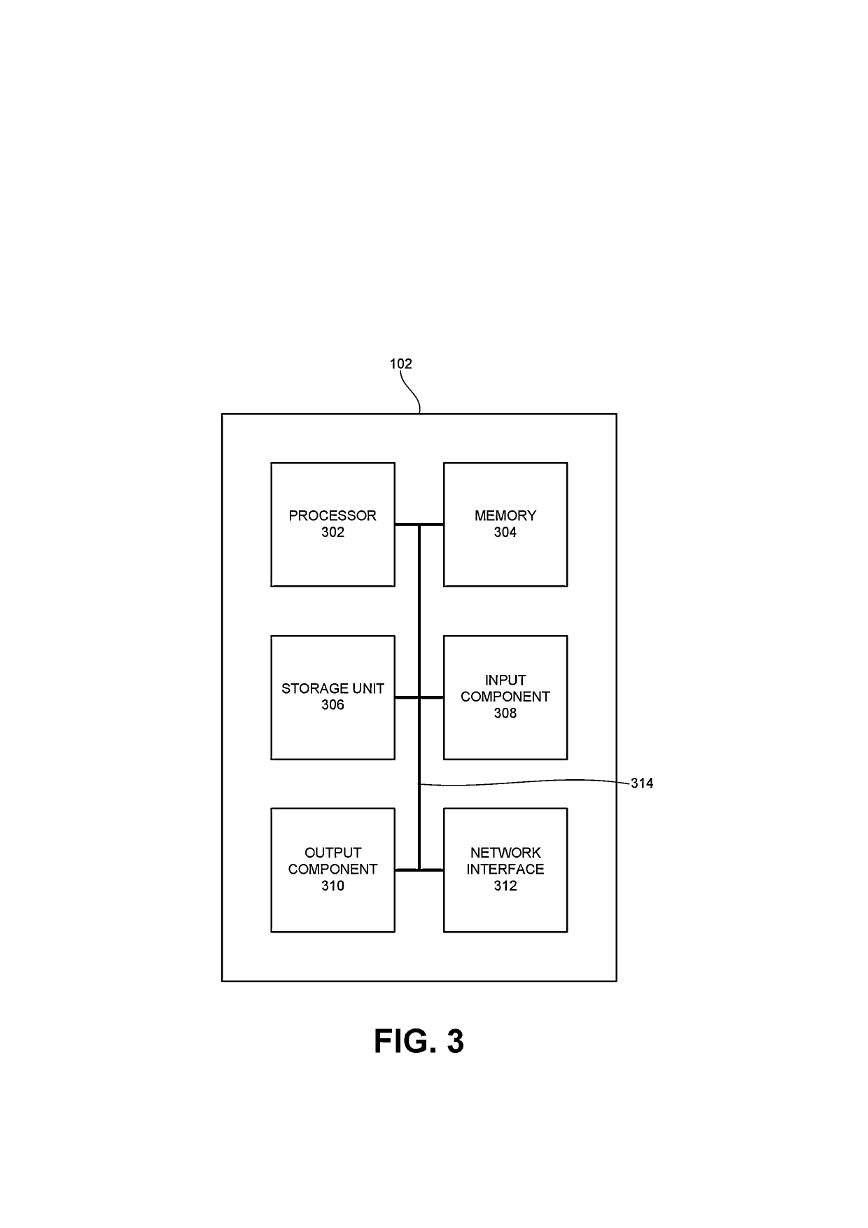

FIGS. 2A and 3B are front and rear views of one implementation of device 102. Device 102 may include any of the following devices that have the ability to or are adapted to display 2D and 3D images, such as a cell phone or a mobile telephone with a 3D display (e.g., smart phone); a tablet computer; an electronic notepad, a gaming console, a laptop, and/or a personal computer with a 3D display; a personal digital assistant (PDA) that can include a 3D display; a peripheral (e.g., wireless headphone, wireless display, etc.); a digital camera; or another type of computational or communication device with a 3D display, etc.

As shown in FIGS. 2A and 2B, device 102 may include a speaker 202, a 3D display 204, a microphone 206, sensors 208, a front camera 210, a rear camera 212, and housing 214. Speaker 202 may provide audible information to a user/viewer of device 102.

3D display 204 may provide two-dimensional or three-dimensional visual information to the user. Examples of 3D display 204 may include an auto-stereoscopic 3D display, a stereoscopic 3D display, a volumetric display, etc. 3D display 204 may include pixels that emit different light rays to viewer 104's right eye 104-1 and left eye 104-2, through optical guide 110 (FIGS. 1A and 1B) (e.g., a lenticular lens, a parallax barrier, etc.) that covers the surface of 3D display 204. Each pixel may include sub-pixels (e.g., red, green, and blue (RGB) sub-pixels). In one implementation, optical guide 110 may dynamically change the directions in which the light rays are emitted from the surface of display 204, depending on input from device 102. In some implementations, 3D display 204 may also include a touch-screen, for receiving user input.

Microphone 206 may receive audible information from the user. Sensors 208 may collect and provide, to device 102, information pertaining to device 102 (e.g., movement, orientation, etc.), information that is used to aid viewer 104 in capturing images (e.g., for providing information for auto-focusing to front/rear cameras 210/212) and/or information tracking viewer 104 (e.g., proximity sensor). For example, sensor 208 may provide acceleration and orientation of device 102 to internal processors. In another example, sensors 208 may provide the distance and the direction of viewer 104 relative to device 102, so that device 102 can determine how to control optical guide 110. Examples of sensors 208 include an accelerometer, gyroscope, ultrasound sensor, an infrared sensor, a camera sensor, a heat sensor/detector, etc.

Front camera 210 and rear camera 212 may enable a user to view, capture, store, and process images of a subject located at the front/back of device 102. Front camera 210 may be separate from rear camera 212 that is located on the back of device 102. In some implementations, device 102 may include yet another camera at either the front or the back of device 102, to provide a pair of 3D cameras on either the front or the back. Housing 214 may provide a casing for components of device 102 and may protect the components from outside elements.

FIG. 3 is a block diagram of device 102. As shown, device 102 may include a processor 302, a memory 304, storage unit 306, input component 308, output component 310, a network interface 312, and a communication path 314. In different implementations, device 102 may include additional, fewer, or different components than the ones illustrated in FIG. 3.

Processor 302 may include a processor, a microprocessor, an Application Specific Integrated Circuit (ASIC), a Field Programmable Gate Array (FPGA), and/or other processing logic capable of controlling device 102. In one implementation, processor 302 may include components that are specifically designed to process 3D images. Memory 304 may include static memory, such as read only memory (ROM), and/or dynamic memory, such as random access memory (RAM), or onboard cache, for storing data and machine-readable instructions.

Storage unit 306 may include a magnetic and/or optical storage/recording medium. In some embodiments, storage unit 306 may be mounted under a directory tree or may be mapped to a drive. Depending on the context, the term “medium,” “memory,” “storage,” “storage device,” “storage medium,” and/or “storage unit” may be used interchangeably. For example, a “computer-readable storage device” or “computer readable storage medium” may refer to both a memory and/or storage device.

Input component 308 may permit a user to input information to device 102. Input component 308 may include, for example, a keyboard, a keypad, a mouse, a pen, a microphone, a touch screen, voice recognition and/or biometric mechanisms, sensors, etc. Output component 310 may output information to the user. Output component 310 may include, for example, a display, a printer, a speaker, etc.

Network interface 312 may include a transceiver that enables device 102 to communicate with other devices and/or systems. For example, network interface 312 may include mechanisms for communicating via a network, such as the Internet, a terrestrial wireless network (e.g., a wireless local area network (WLAN)), a satellite-based network, a personal area network (PAN), a WPAN, etc. Additionally or alternatively, network interface 312 may include a modem, an Ethernet interface to a LAN, and/or an interface/connection for connecting device 102 to other devices (e.g., a Bluetooth interface).

Communication path 314 may provide an interface through which components of device 102 can communicate with one another.

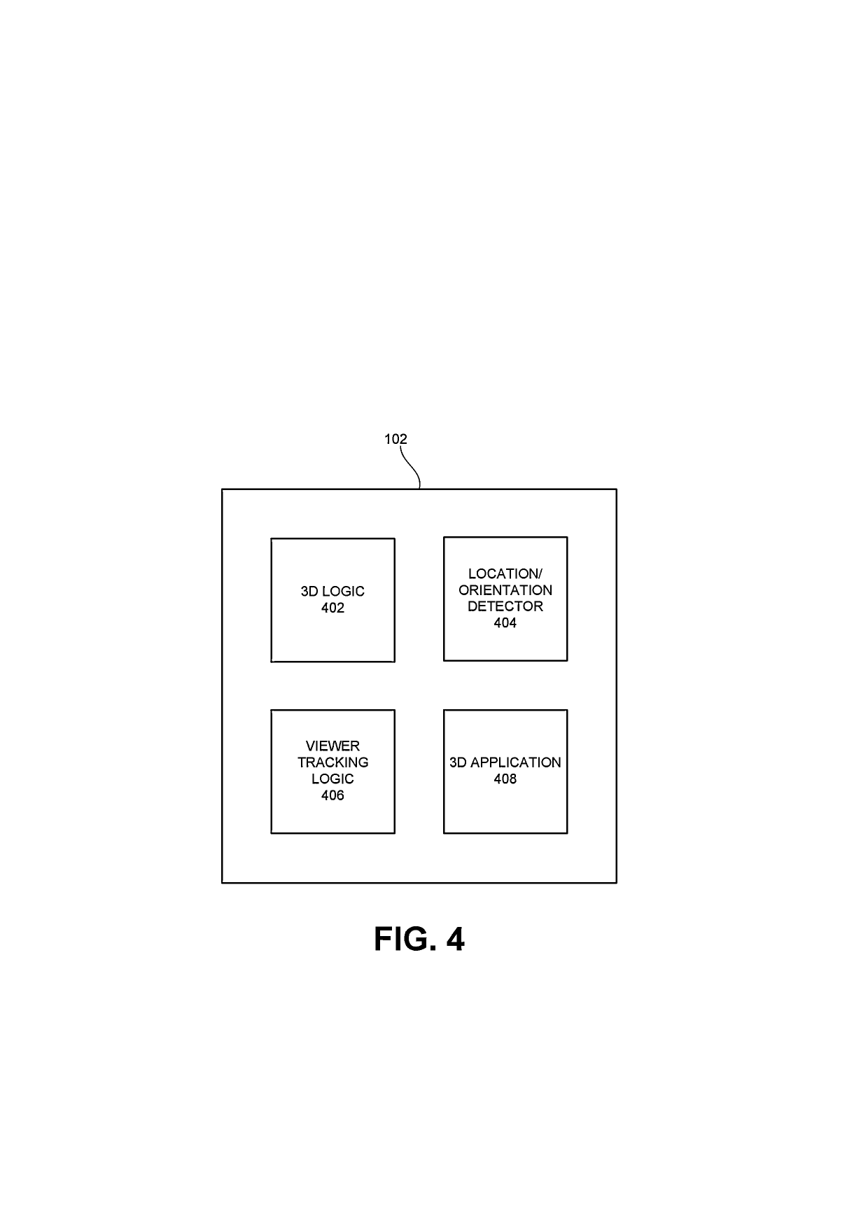

FIG. 4 is a functional block diagram of device 102. As shown, device 102 may include 3D logic 402, location/orientation detector 404, viewer tracking logic 406, and 3D application 408. Although not illustrated in FIG. 4, device 102 may include additional functional components, such as the components that are shown in FIG. 4, an operating system (e.g., Windows Mobile OS, Blackberry OS, Linux, Android, iOS, Windows Phone, etc.), an application (e.g., an instant messenger client, an email client, etc.), etc.

3D logic 402 may include hardware and/or software components for obtaining right-eye images and left-eye images and/or providing the right/left-eye images to a 3D display (e.g., display 204). In obtaining the right-eye and left-eye images, 3D logic 402 may receive right- and left-eye images from stored media content (e.g., a 3D movie). In other implementations, 3D logic 402 may generate the right and left-eye images of a 3D model or object for different pixels or sub-pixels. In such instances, device 102 may obtain projections of the 3D object onto 3D display 108.

In some implementations, 3D logic 402 may receive viewer input for selecting a sweet spot. In one implementation, when a viewer selects a sweet spot (e.g., by pressing a button on device 102), device 102 may store values of control variables that characterize optical guide 110, the location/orientation of user device 102, and/or the relative location of viewer 104. In another implementation, when the user selects a sweet spot, device 102 may recalibrate optical guide 110 such that the stereoscopic images are sent to the selected spot. In either case, as the viewer's relative location moves away from the established sweet spot, 3D logic 402 may determine (e.g., calculate) new directions to which light rays must be guided via optical guide 110.

In some implementations, the orientation of device 102 may affect the relative location of sweet spots. Accordingly, making proper adjustments to the angles at which the light rays from device 102 are directed, via optical guide 110, may be used in locking the sweet spot for viewer 104. The adjustments may be useful, for example, when device 102 is relatively unstable (e.g., being held by a hand). As described below, depending on the implementation, 3D logic 402 may make different types of adjustments to optical guide 110.

Returning to FIG. 4, location/orientation detector 404 may determine the location/orientation of device 102 and provide location/orientation information to 3D logic 402, viewer tracking logic 406, and/or 3D application 408. In one implementation, location/orientation detector 404 may obtain the information from a Global Positioning System (GPS) receiver, gyroscope, accelerometer, etc. in device 102.

Viewer tracking logic 406 may include hardware and/or software (e.g., a range finder, proximity sensor, cameras, image detector, etc.) for tracking viewer 104 and/or part of viewer 104 (e.g., head, eyes, the distance from display 204, the distance between viewer's eyes, etc.) and providing the location/position of viewer 104 or viwer 104's eyes to 3D logic 402. In some implementations, viewer tracking logic 406 may include sensors (e.g., sensors 208) and/or logic for determining a location of viewer 104's head or eyes based on sensor inputs (e.g., distance information from sensors, an image of a face, an image of eyes 104-1 and 104-2 from cameras, etc.).

3D application 408 may include hardware and/or software that shows 3D images on display 108. In showing the 3D images, 3D application 408 may use 3D logic 402, location/orientation detector 404, and/or viewer tracking logic 406 to generate 3D images and/or provide the 3D images to display 108. Examples of 3D application 408 may include a 3D graphics game, a 3D movie player, etc.

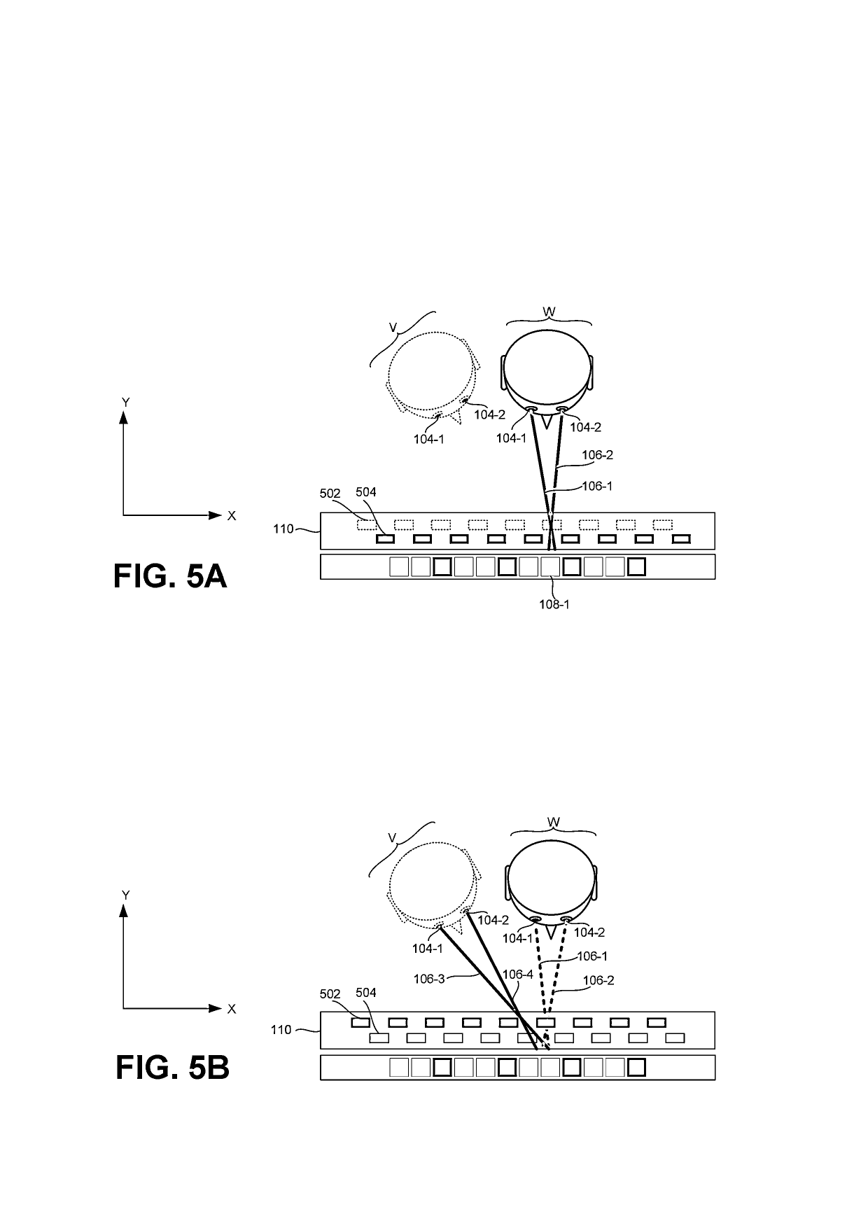

FIGS. 5A and 5B illustrate exemplary operation of optical guide 110 according to one embodiment. In this embodiment, for example, optical guide 110 may be implemented as multiple layers of optical elements. FIG. 5A shows two layers of parallax barrier elements, which may include, for example, indium tin oxide. Each layer may be associated with a set of sweet spots. The two layers are staggered such that the sweet spots of the upper layer fill the spaces between the sweet spots of the lower layer. Two optical elements of optical guide 110 are shown as barrier elements 502 and 504. Element 502 belongs to an upper layer and element 504 belongs to a lower layer. As used herein, the terms “elements 502” and “elements 504” will refer to all of the barrier elements of the upper layer and all of the barrier elements of the lower layer, respectively.

In FIG. 5A, each layer of the barrier elements may be capable of being in one of multiple states. In one state, a barrier element may block light from passing through the element (e.g., opaque or reflective state. In another state, the barrier element may let the light pass through relatively unchanged (e.g., transparent state). The barrier elements of one layer may be synchronized to one another, to be in either the opaque state or the transparent state.

For example, in one implementation, as shown, barrier elements 502 are in the transparent state. Their positions allow light rays from pixel 108-1 to pass unimpeded and reach right eye 104-1 of viewer 104 at position W. Barrier elements 504 in the lower layer are in the opaque state, thus, setting the sweet spots for viewer 104. In this configuration, the lower layer prevents some of light rays from the pixels on display 108 from forming pseudo-stereoscopic images and allows other rays to form stereoscopic images. That is, light is selectively allowed to pass to viewer 104 to provide stereoscopic images for viewer 104.

When in operation, 3D logic 402 may determine, based on the current visibility states of optical guide 110 (e.g., barrier elements 502 are in the transparent state and barrier elements 504 are in the opaque state) and viewer 104's location, new visibility states (i.e., the control variables) of the upper and lower layers. In one implementation, 3D logic 402 may determine the new visibility states by first determining whether viewer 104 is already in or is close to one of the sweet spots that are associated with the opaque layer. If not, 3D logic 402 may switch the visibility states of the lower layer and the upper layer.

In another implementation, 3D logic 402 may determine the new visibility states by determining whether light rays from particular pixels generate pseudo-stereoscopic images at viewer 104's location. In still yet another implementation, 3D logic 402 may determine whether viewer 104 is closer to one of the sweet spots that are associated with the currently opaque layer than to one of the sweet spots that are associated with the currently transparent layer. If viewer 104 is closer to one of the sweet spots associated with the transparent layer, 3D logic 402 may switch the visibility states of the upper and lower layers. That is, barrier element 502 may switch from transparent to opaque state and barrier element 504 may switch from opaque to transparent state (or vice versa).

For example, in FIG. 5A, display 108 transmits light rays 106-1 and 106-2 to right eye 104-1 and left eye 104-2, respectively, of viewer 104 at location W. When viewer 104 moves to location V, 3D logic 402 may determine that viewer 104 has moved out of a sweet spot associated with the upper layer and has moved closer to one of the sweet spots associated with the lower layer. Based on viewer's new location V and the current states of the upper and lower layers, 3D logic 402 may switch the visibility states for the upper and lower layer optical elements 502 and 504, such that viewer 104 would be closer to or at the one of the sweet spots associated with the lower layer.

FIG. 5B shows the end states of the two optical element layers. As shown, the upper layer of optical elements 502 are in the opaque state, and the lower layer of optical elements 504 is in the transparent state. As further shown, after the state change, viewer 104 (at location V) is in a sweet spot associated with the lower layer of light guide 110. This may decrease the ratio of power associated with pseudo-stereoscopic images to power associated with stereoscopic images.

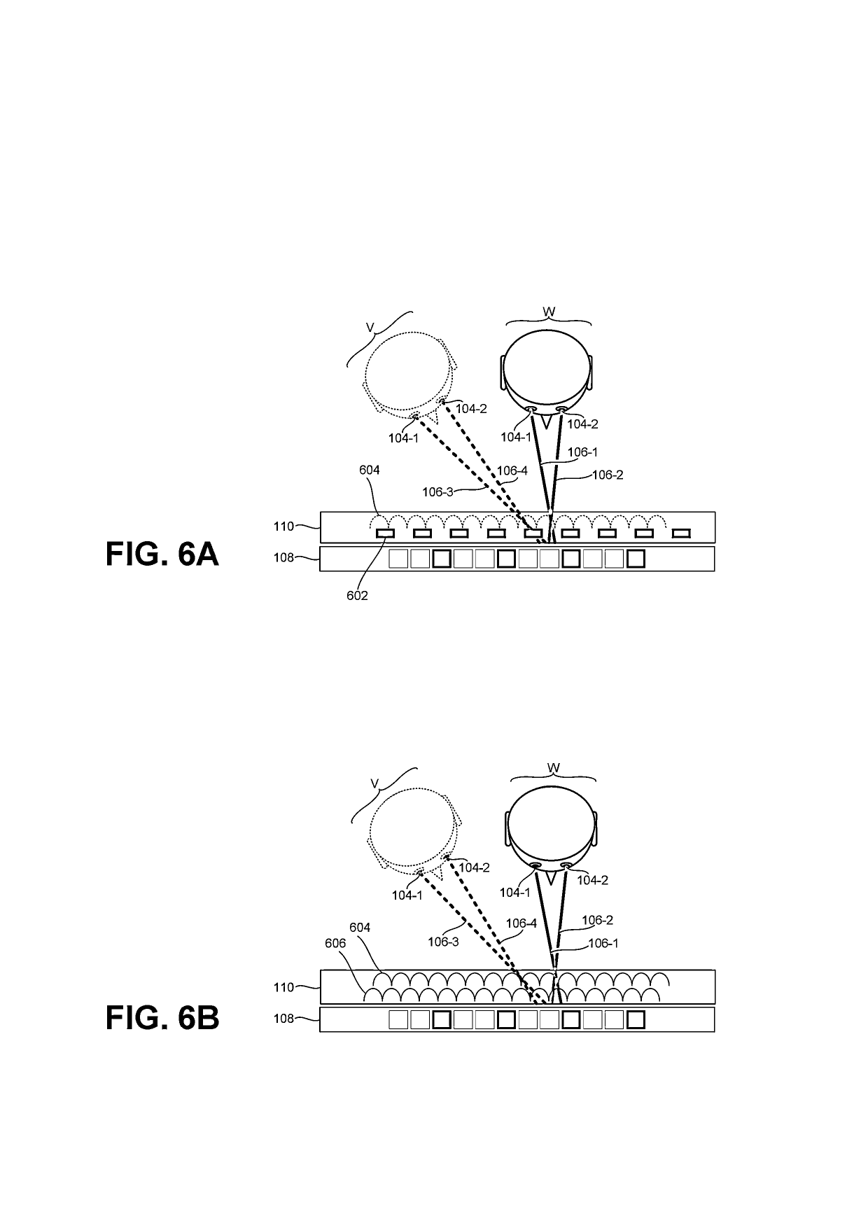

FIG. 6A illustrates exemplary operation of optical guide 110 according to another embodiment. As in FIGS. 5A and 5B, optical guide 110 may include multiple layers of optical elements. For example, optical guide 110 may be implemented as a multiple layers of different optical elements, such as parallax barrier elements, lenticular lens elements, prism elements, grating elements, etc. Each layer may be associated with a set of sweet spots. The two layers are configured such that the sweets spots of the upper layer fill the spaces between the sweet spots of the lower layer. FIG. 6A shows two layers of optical elements, two of which are shown as a parallax barrier element 602 and lenticular lens element 604. Element 602 belongs to a lower layer and element 604 belongs to an upper layer, which will be herein collectively referred to as elements 602 and elements 604, respectively.

In FIG. 6A, device 102 may control each layer of the optical elements. For example, in some implementations, the lenticular lens layer (the upper layer) may be capable of changing its optical properties (e.g., index of refraction, surface deformation, etc.). In these implementations, device 102 may change the optical and/or physical/spatial properties of the lenticular elements to change its visibility state. In addition, device 102 may change the visibility state of the barrier layer (the lower layer).

When in operation, 3D logic 402 may determine, based on the current visibility state of optical guide 110 (e.g., the upper layer optical elements 604 are in the transparent state and the lower layer optical elements 602 are in the opaque state) and viewer 104's location, new visibility states of the upper and lower layers. In one implementation, 3D logic 402 may determine the new visibility states by determining whether viewer 104 is in one of the sweet spots that are associated with its opaque layer. If not, 3D logic 402 may switch the visibility states of the lower layer and the upper layer. That is, 3D logic 402 may switch elements 604 from the transparent state to the opaque state and switch elements 602 from the opaque state to the transparent state, or vice versa.

In another implementation, 3D logic 402 may determine the new visibility states by determining whether light rays from particular pixels generate pseudo-stereoscopic images at viewer 104's location. In still yet another implementation, 3D logic 402 may determine whether viewer 104 is closer to one of the sweet spots that are associated with the currently opaque layer than to one of the sweet spots that are associated with the currently transparent layer. If viewer 104 is closer to one of the sweet spots associated with the transparent layer, 3D logic 402 may switch the states of the upper and lower layers.

For example, in FIG. 6A, display 108 transmits light rays 106-1 and 106-2 to right eye 104-1 and left eye 104-2, respectively, of viewer 104 at location W. When viewer 104 moves to location V, 3D logic 402 may determine that viewer 104 has moved out of a sweet spot associated with the upper layer and has moved closer to one of the sweet spots associated with the lower layer. Based on viewer's new location V and the current states of the upper and lower layers, 3D logic 402 may switch the visibility states for the upper and lower layer optical elements 602 and 604, respectively, such that viewer 104 would be closer to or at the one of the sweet spots associated with the lower layer.

FIG. 6B illustrates exemplary operation of optical guide 110 according to yet another embodiment. As in FIG. 6A, optical guide 110 may include multiple layers of optical elements, arranged similarly as the corresponding layers in FIG. 6A. FIG. 6B shows two layers of optical elements, two of which are shown as lenticular lens element 604 and lenticular lens element 606. Element 604 belongs to an upper layer as in FIG. 6A and element 606 belongs to a lower layer.

Optical guide 110 in FIG. 6B operates similarly as optical guide 110 in FIG. 6A, except that in FIG. 6B, both layers are lenticular lens element layers. Accordingly, the control variables for each layer include the visibility states of the lenticular lens elements. Device 102 may change the visibility states by altering optical characteristic/properties of the lenticular lens layer (e.g., index of refraction, the curvature of lenticular lens layer elements, positions of the upper and lower layer relative to display 108, etc.).

Although the optical elements in FIGS. 5A, 5B, 6A, and 6B are shown as either parallax barrier elements or lenticular lens elements, in other implementations, the optical elements may include other types of components, such as a prism element, grating element, etc. These elements may change their optical and/or physical properties in response to control signals from 3D logic 402, as described above with reference to FIGS. 5A, 5B, 6A, and 6B.

In FIGS. 5A, 5B, 6A, and 6B, by changing the visibility states of the layers and/or elements of the layers, device 102 may decrease the ratio of power associated with pseudo-stereoscopic images to power associated with stereoscopic images at viewer 104's location. Rendering one layer transparent and another layer opaque replaces sweet spots that are associated with the one layer with the sweet spots of the other layer.

### Exemplary Process for Eliminating Pseudo-stereoscopic Images Based on Viewer/device Tracking

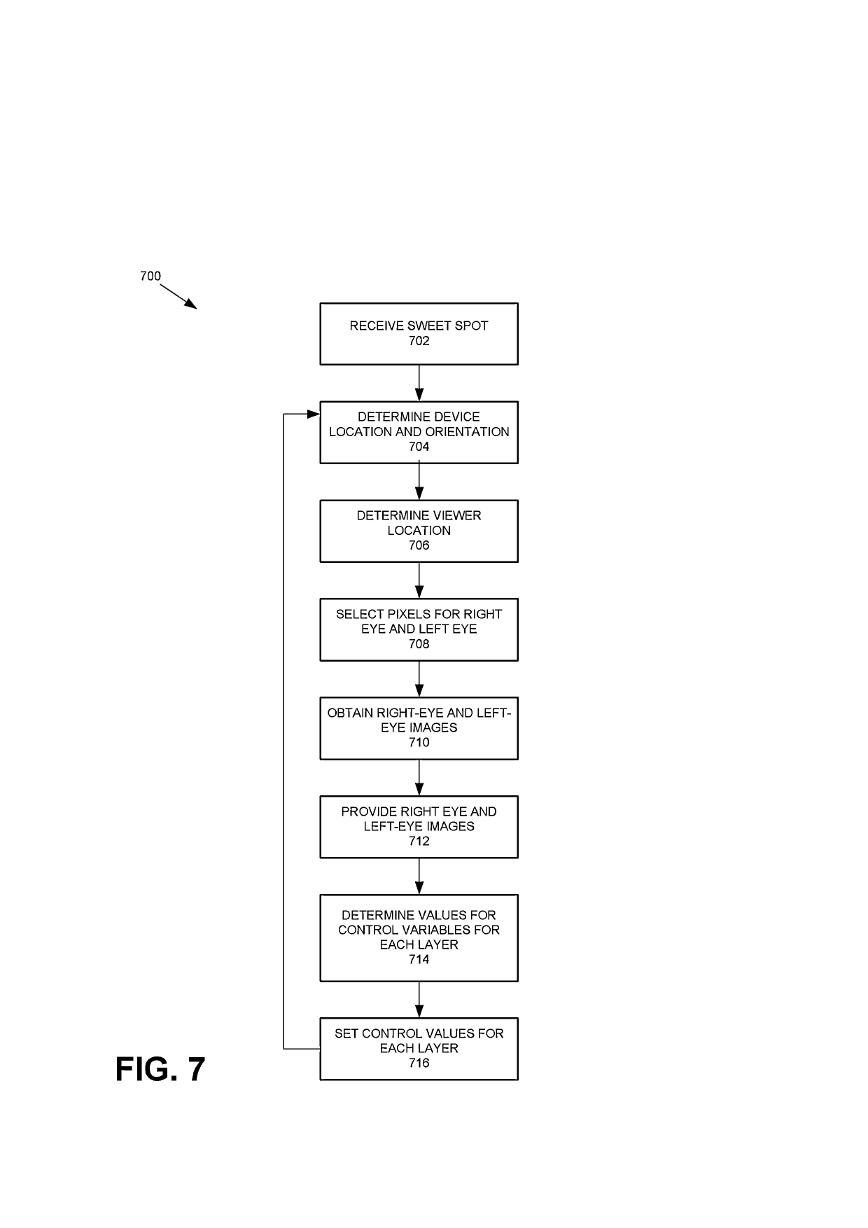

FIG. 7 is a flow diagram of an exemplary process 700 for eliminating pseudo-stereoscopic images by device 102, based on tracking device 102 and/or viewer 104. Assume that 3D logic 402 and/or 3D application 408 is executing on device 102. Process 700 may include receiving a viewer input for selecting a sweet spot (block 702). For example, viewer 104 may indicate that viewer 104 is in a sweet spot by pressing a button on device 102, touching a soft switch on display 204 of device 102, etc. In response to the viewer input, 3D logic 402/3D application 408 may store the values of control variables (e.g., angles at which optical guide 110 or the optical elements are sending light rays from pixels, the location/orientation of device 102, the relative location of viewer 104 or part of viewer 104's body (e.g., viewer 104's head, viewer 104's eyes, etc.), identities of pixels that are sending images to the right eye and of pixels that are sending images to the left eye, etc.). In some implementations, block 702 may be omitted, as sweet spots for device 102 may be pre-configured.

Device 102 may determine device 102's location and/or orientation (block 704). In one implementation, device 102 may obtain its location and orientation from location/orientation detector 404 (e.g., information from GPS receiver, gyroscope, accelerometer, etc.).

Device 102 may determine viewer 104's location (block 706). Depending on the implementation, device 102 may determine viewer 104 location in one of several ways. For example, in one implementation, device 102 may use a proximity sensor (e.g., sensors 208) to locate viewer 104 (e.g., distance from the viewer's eyes to device 102/display 108 and an angle (e.g., measured normal to display 108). In another implementation, device 102 may sample images of viewer 104 (e.g., via camera 210 or 212) and perform object detection (e.g., to locate the viewer's eyes, to determine the distance between the eyes, to recognize the face, to determine tilt of the viewer's head, etc.). Such information may be used to determine stereoscopic images and pseudo-stereoscopic images (projected from display 108) at right eye 104-1 and left eye 104-2 of viewer 104.

Device 102 may select or determine pixels, on display 108, that are configured to convey right-eye images to right eye 104-1 (i.e., right-eye image pixels) and pixels, on display 108, that are configured to convey left-eye images to left eye 104-2 (i.e., left-eye image pixels) (block 708). Depending on the implementation, the left- and right-eye image pixels may already be set, or alternatively, device 102 may dynamically determine the right-eye image pixels and left-eye image pixels.

Device 102 may obtain right-eye and left-eye images (block 710). For example, in one implementation, 3D application 408 may obtain right-eye and left-eye images from a media stream from a content provider over a network. In another implementation, 3D application 408 may generate the images from a 3D model or object based on viewer 104's relative location from display 108 or device 102.

Device 102 may provide the right-eye image and the left-eye image to the selected right- and left-eye image pixels on display 108 (block 712). Furthermore, device 102 may determine values for control variables for each layer of optical elements in optical guide 110, based on viewer 104 tracking (e.g., tracking viewer 104's eyes, head, etc.) and device 102 tracking, to dynamically configure optical guide 110. As indicated above, the control variables may include the visibility states of the upper or lower layer of optical elements (e.g., elements 502, 504, 602, and 604). In some implementations, the visibility states may depend on optical properties, such as the index of refraction, the surface contour of the lens that may deform in accordance with signals, etc.

Each determined value of the control variables may reflect, for viewer 104, strength or power of stereoscopic image relative to that of pseudo-stereoscopic image. For example, in some implementations, device 102 may change the visibility states of the upper and lower layers of parallax barrier elements, to obtain a particular ratio (e.g., a value greater than a threshold) of the stereoscopic image power to pseudo-stereoscopic image power (e.g., a maximum value).

Depending on the implementation, 3D logic 402 may use different approaches to determine the values of control variables for the layers of optical elements. In some implementations, 3D logic 402 may access a function whose evaluation entails operation of a hardware component, execution of a software program, or look up of a table. In one implementation, the function may accept viewer 104's relative location and may output the visibility states based on calculated ratio of power of the stereoscopic image to power of the pseudo-stereoscopic image.

When the function is implemented as a table, 3D logic 402 may look up the control values (i.e., values of the control variables) based on viewer's location relative to display 108. Evaluating the function can be fast, since the values of the table are pre-computed (e.g., based on ratios of power contributed via an optical element in forming a stereoscopic image to power contributed via the optical element in forming pseudo-stereoscopic images).

Device 102 may set the values of control variables for each layer of the optical elements (block 716). Setting the control values may send the light rays from a right-eye image to right eye 104-1 and a left-eye image to left eye 104-2. Processing may continue in this manner, with device 102 changing the optical characteristics of the optical elements, as viewer 104 moves or as device 102 moves relative to viewer 104.

In some implementations, device 102 may time multiplex left-eye images and right-eye images via the same set of pixels. (e.g. send a right-eye image to a set of pixels for a brief interval and send a left-eye image to the same set of pixels for the following interval).

In these implementations, device may control the optical elements, to send a right-eye image from display 108 to right-eye 104-1 when the right-eye image is on display 108 and to send a left eye-image from display 108 to left-eye 104-2 when the left-eye image is on display 108.

In some implementations, the number of viewers that device 102 can support with respect to displaying 3D images may be greater than one (i.e., more than one viewer can see 3D images on display 108 at the same time). In such instances, some pixels may send images for the right eye of a first viewer, some pixels may send images to the left eye of the first viewer, some pixels may send images to the right eye of a second viewer, etc. Each optical element may guide light rays from each pixel to the right of left eye of a particular viewer based on location information associated with the viewers.

In other implementations, at least some of the pixels may multiplex images for multiple viewers. Device 102 may control the optical elements (i.e., change the control values), such that the optical elements guide light rays from each image on display 108 to a particular viewer/eyes.

### Conclusion

The foregoing description of implementations provides illustration, but is not intended to be exhaustive or to limit the implementations to the precise form disclosed. Modifications and variations are possible in light of the above teachings or may be acquired from practice of the teachings.

For example, device 102 may change optical properties via micro-electromechanical system (MEMS) components. In other implementations, device 102 may modify the optical properties (e.g., visibility states) of optical elements via other types of components, such as muscle wires, memory alloys (e.g., alloys that change shape and return to the shape), piezoelectric components (e.g., actuators), controllable polymers, etc. In another example, device 102 may include more than two layers of optical elements. Yet in another example, each of optical elements may be individually controlled (e.g., change index of refraction, translate, rotate, etc.).

In the above, while a series of blocks has been described with regard to exemplary processes 700 illustrated in FIG. 7, the order of the blocks in processes 700 may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

It should be emphasized that the term “comprises/comprising” when used in this specification is taken to specify the presence of stated features, integers, steps or components but does not preclude the presence or addition of one or more other features, integers, steps, components, or groups thereof

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
determining a position of a user relative to a display of a device to obtain position information, wherein the device includes the display and an optical guide, wherein the display includes pixels for displaying images, and wherein the optical guide includes at least two layers of optical elements for directing light rays from the pixels;
obtaining control values based on the position information;
displaying a stereoscopic image at the display; and
changing sweet spots associated with the optical guide based on the obtained control values.

2. The method of claim 1, wherein obtaining the control values includes:
for each of the at least two layers, selecting one of an opaque state or a transparent state.

3. The method of claim 1, wherein changing the sweets spots includes replacing sweet spots that are associated with one of the two layers with sweet spots that are associated with the other of the two layers.

4. The method of claim 1, wherein the at least two layers include:
a parallax barrier element layer; a prism element layer; a grating element layer; or a lenticular lens element layer.

5. The method of claim 1, wherein obtaining the control values includes:
selecting values for controlling micro-electromechanical system (MEMS) component, a muscle wire, memory alloys, a piezoelectric component, or controllable polymer to rotate or translate the optical elements.

6. The method of claim 1, wherein the stereoscopic image includes a right-eye image and a left-eye image, and wherein changing the sweet spots includes:
directing the right-eye image to the right-eye of the user during a first time interval; and
directing the left-eye image to the left-eye of the user during a second time interval following the first time interval.

7. The method of claim 1, further comprising:
receiving a user selection of a predefined location associated with receiving the stereoscopic image.

8. The method of claim 1, further comprising:
determining a second position of a second user relative to the display to obtain second position information;
displaying a second stereoscopic image at the display concurrently with the stereoscopic image; and
controlling the at least two layers of optical elements to send light rays from the pixels of the display to convey the second stereoscopic image to the second position of the second user.

9. The method of claim 1, wherein obtaining the control values includes:
determining values for control variables associated with the at least two layers of optical elements to change relative power associated with the stereoscopic image in relation to power associated with the pseudo-stereoscopic image at the determined position of the user.

10. The method of claim 9, wherein determining the values includes:
looking up a table of values of the control variables, wherein the values are pre-computed based on ratios of the power associated with the stereoscopic image to the power associated with the pseudo-stereoscopic image.

11. The method of claim 10, wherein looking up includes identifying the values for the control variables based on the position of the user.

12. A device comprising:
sensors for obtaining tracking information associated with a user;
a display including pixels for displaying images;
an optical guide including two layers of optical elements, each of the optical elements blocking or directing light rays from one or more of the pixels; and
one or more processors to:
determine a relative location of the user based on the tracking information obtained by the sensors;
control optical characteristics of each of the two layers of optical elements based on the relative location of the user; and
display a stereoscopic image via the display.

13. The device of claim 12, wherein the sensors include at least one of:
a gyroscope; a camera; a proximity sensor; or an accelerometer.

14. The device of claim 12, wherein the device includes:
a tablet computer; a cellular phone; a personal digital assistant; a personal computer; a laptop computer; a camera; or a gaming console.

15. The device of claim 12, wherein the two layers include at least one of:
a parallax barrier element layer; a lenticular lens element layer; a prism element layer; or a grating element layer.

16. The device of claim 12, wherein the two layers are configured to overlap one another and wherein sweet spots that are associated with one of the two layers are located between sweet spots that are associated with the other of the two layers.

17. The device of claim 12, wherein optical elements of one of the two layers are opaque when optical elements of the other of the two layers are transparent.

18. The device of claim 12, wherein the one or more processors are further configured to prevent a formation of a pseudo-stereoscopic image,
wherein the stereoscopic image includes a right eye image and a left-eye image at a right-eye position and a left-eye position that are associated with the relative location, respectively, and the pseudo-stereoscopic image includes one of a left-eye image or a right-eye image at the right-eye position and the left-eye position, respectively.

19. The device of claim 12, wherein when the one or more processors control the optical characteristics, the one or more processors are further configured to shift sweets spots associated with the display from one set of locations to another set of locations.

20. A device comprising:
sensors for providing tracking information associated with a user;
a display including pixels;
a first layer of parallax barrier elements for allowing or blocking light rays from one or more of the pixels to a right eye or a left eye of the user;
a second layer of parallax barrier elements for allowing or blocking light rays from the one or more of the pixels to the right eye or the left eye of the user;
one or more processors to:
determine a relative location of the user based on the tracking information;
obtain values of control variables for the first layer and the second layer based on the relative location of the right eye and the left eye;
display a stereoscopic image via the display, the stereoscopic image comprising a right-eye image and a left-eye image; and
change visibility states of the first layer and the second layer of parallax barrier elements based on the control values, to shift a sweet spot associated with the stereoscopic image toward the right eye and left eye of the user.
